(19) United States
(12) Patent Application Publication
(10) Pub. No.: US 2026/0304102 A1
(43) Pub. Date: Oct. 1, 2026

(54) TECHNOLOGIES FOR ARTIFICIAL INTELLIGENCE PROCESSING CAPABILITY

(71) Applicant: Apple Inc., Cupertino, CA (US)

(72) Inventors: Huaning Niu, San Jose, CA (US); Amal Ekbal, San Antonio, TX (US); Haitong Sun, Saratoga, CA (US); Oghenekome Oteri, San Diego, CA (US); Parvathanathan Subrahmanya, Sunnyvale, CA (US); Wanshi Chen, San Diego, CA (US); Wei Zeng, Saratoga, CA (US); Weidong Yang, San Diego, CA (US)

(73) Assignee: Apple Inc., Cupertino, CA (US)

(21) Appl. No.: 19/551,553

(22) Filed: Feb. 26, 2026

Related U.S. Application Data
(60) Provisional application No. 63/779,177, filed on Mar. 27, 2025.

(51) Int. Cl. H04W 8/22; H04B 7/06; H04B 17/309; H04B 17/318; H04L 5/00; H04L 41/16

(52) U.S. Cl. CPC H04W 8/22; H04B 7/0626; H04B 17/328; H04B 17/346; H04L 5/001; H04L 41/16

(57) ABSTRACT

The present application relates to devices and components including apparatuses, systems, and methods for artificial intelligence processing capability.

### CROSS-REFERENCE TO RELATED APPLICATION

This application claims priority to U.S. Provisional Patent Application No. 63/779,177, entitled “TECHNOLOGIES FOR ARTIFICIAL INTELLIGENCE PROCESSING CAPABILITY,” filed on Mar. 27, 2025, which is herein incorporated by reference in its entirety for all purposes.

### TECHNICAL FIELD

This application relates generally to communication networks and, in particular, to technologies for artificial intelligence processing capability.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example procedure in accordance with some embodiments.

FIGS. 3A and 3B illustrate examples of resource sets in accordance with some embodiments.

FIG. 4 illustrates an operation flow/algorithmic structure in accordance with some embodiments.

FIG. 5 illustrates another operation flow/algorithmic structure in accordance with some embodiments.

FIG. 6 illustrates another operation flow/algorithmic structure in accordance with some embodiments.

FIG. 7 illustrates a user equipment in accordance with some embodiments.

FIG. 8 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to an apparatus, circuitry, device, or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

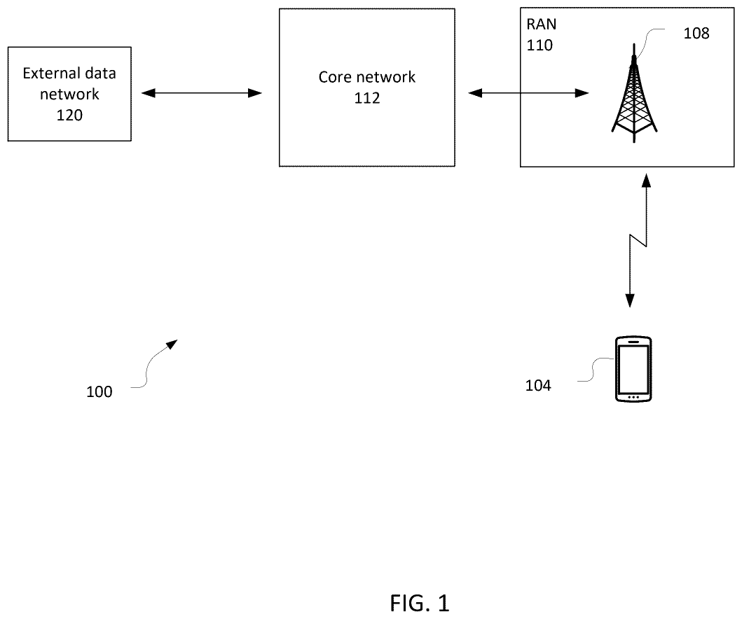

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system, a Sixth Generation (6G) system, or a later system. The base station 108 may provide user plane and control plane protocol terminations toward the UE 104.

The network environment 100 may further include a core network 112. For example, the core network 112 may comprise a 5G core network (5GC), a 6G core network (6GC), or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

The network environment 100 may further include an external data network 120 with which the UE 104 may connect via the RAN 110. Data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

Operations described herein as performed by a device (for example, UE 104, base station 108, and/or a device of core network 112) may be fully, substantially, or partially performed by processing circuitry implemented on the device. Additionally, operations described herein as performed by “the network” may be performed by a device of the RAN 110 (e.g., base station 108), a device of the core network 112, and/or components thereof.

In operation, the base station 108 may transmit downlink reference signals that the UE 104 measures to determine channel state information (CSI). The downlink reference signals may include CSI-reference signals (CSI-RSs) or synchronization signal blocks (SSBs). The CSI may include a channel quality indicator (CQI), a rank indicator (RI), a precoding matrix indicator (PMI), an SSB resource indicator (SSBRI), a CSI-RS resource indicator (CRI), a layer indicator (LI), or layer 1-reference signal receive power (L1-RSRP). The base station 108 may use the CSI to support downlink transmissions on a physical downlink shared channel (PDSCH) and physical downlink control channel (PDCCH).

NR networks support three types of the CSI measurement resources. Periodic CSI measurement resources may include CSI-RS or SSB and may be configured and released by radio resource control (RRC) signaling. Semi-persistent CSI measurement resources may include CSI-RS and may be activated and deactivated by media access control (MAC)-control element (CE). Aperiodic CSI measurement resources may include CSI-RS and may be triggered by downlink control information (DCI).

NR networks support three types of CSI reports: aperiodic CSI reports, semi-persistent CSI reports, and aperiodic CSI reports.

The periodic CSI reports may be carried by a physical uplink control channel (PUCCH). The periodic CSI report may be both configured and released by RRC signaling. The periodic CSI report may rely on periodic measurement resources (for example, CSI-RS or SSB).

A first type of semi-persistent CSI report may also be carried by the PUCCH. The first type of semi-persistent CSI report may be activated and deactivated by MAC-CE. The first type of semi-persistent CSI report may rely on periodic measurement resources (for example, CSI-RS or SSB) or semi-persistent measurement resources (for example, CSI-RS).

A second type of semi-persistent CSI report may be carried by a physical uplink shared channel (PUSCH). The second type of semi-persistent CSI report may be activated and deactivated by DCI. The second type of semi-persistent CSI report may rely on periodic measurement resources (for example, CSI-RS or SSB) or semi-persistent measurement resources (for example, CSI-RS).

The aperiodic CSI report may be carried by the PUSCH and may be triggered by DCI. The aperiodic CSI report may rely on periodic measurement resources (for example, CSI-RS or SSB), semi-persistent measurement resources (for example, CSI-RS), or aperiodic measurement resources (for example, CSI-RS).

CSI processing constraints on the UE 104 may limit the number of CSI reports and/or CSI calculations the UE 104 is expected to handle at a given time. For example, Section 5.2.1.6 of 3GPP TS 38.214 v18.5.0 (2025 Jan. 10) (hereinafter “TS 38.214”) specifies that the UE indicates the number of supported simultaneous CSI calculations N_{CPU} with parameter simultaneousCSI-ReportsPerCC in a component carrier, and simultaneousCSI-ReportsAllCC across all component carriers. If a UE supports N_{CPU} simultaneous CSI calculations it is said to have N_{CPU} CSI processing units (CPUs) for processing CSI reports. The UE is not required to update requested CSI reports with a lowest priority when the associated number of CPUs exceeds the number of supported CPUs.

In embodiments, the UE 104 may perform calculations (e.g., inferences) using one or more artificial intelligence/machine learning (ML) models. For example, the UE 104 may use an AI/ML model for CSI (e.g., CSI prediction, CSI-RS estimation, and/or CSI compression) and/or other use cases, such as beam management (e.g., beam prediction) and/or positioning. In embodiments, an AI processing unit (aiPU) may be defined to represent UE processing capabilities related to AI/ML calculations.

Various embodiments herein provide a framework for a processing pool including aiPUs, including how aiPUs are handled with respect to CPUs and for different AI/ML use cases. For example, aspects of various embodiments may include a designated total set of aiPUs for AI/ML related processing, e.g., maximum number of simultaneous AI inference per CC or for all CCs. Embodiments may further include a designated processing pool (e.g., subset of aiPUs) for one or more AI/ML use cases. For example, embodiments may include a designated maximum simultaneous processing capability per use case. In embodiments, the aiPU may be flexibly (e.g., dynamically) defined. Embodiments may further relate to UE capability reporting associated with aiPUs.

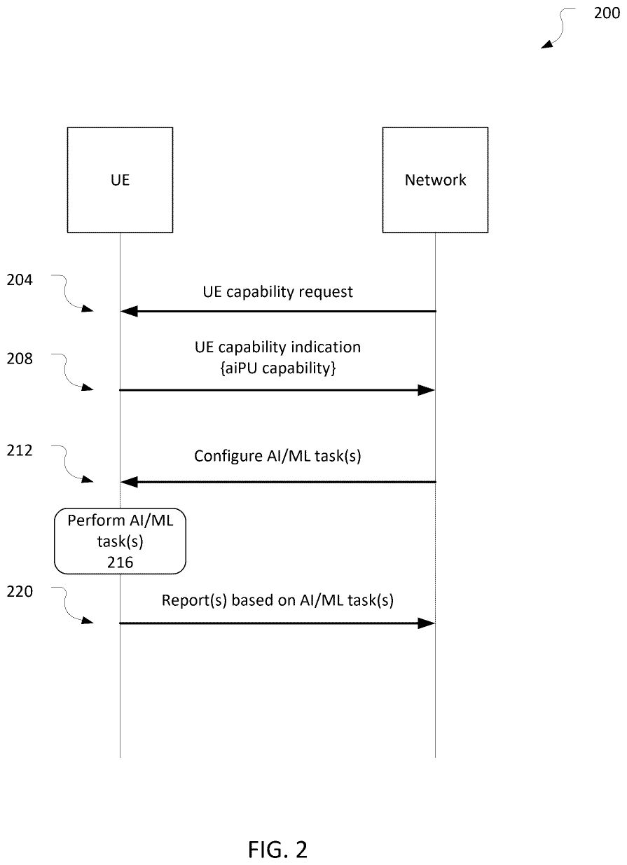

FIG. 2 illustrates an example procedure 200 in accordance with some embodiments. Aspects of the procedure 200 may be performed by a UE (e.g., UE 104) and/or a network (e.g., base station 108), or components thereof (e.g., processor circuitry).

At 204 of the procedure 200, the network may transmit a request to the UE for UE capability information. In some embodiments, the request may include a request for aiPU capability information.

At 208 of the procedure 200, the UE may transmit a UE capability indication to the network. The UE capability indication may indicate an aiPU capability, e.g., a processing capability associated with aiPUs supported by the UE. In an example, the aiPU capability may be designated for AI-related processing. The aiPU may be separate from the CPU defined for non-AI related processing. Accordingly, the UE may send a separate capability indication to indicate support for CPUs and/or other processing capabilities. The indication of aiPU support and the indication of CPU support may be included in the same message or in different messages.

In some embodiments, the UE capability indication may be transmitted via RRC signaling. For example, the UE capability indication may be transmitted via UE assistance information.

At 212 of the procedure 200, the network may configure one or more AI/ML tasks for the UE based on the UE capability indication. For example, the one or more AI/ML tasks may include CSI prediction, CSI compression, beam management, demodulation reference signal (DMRS) estimation, CSI-RS estimation, positioning, and/or sensing.

At 216 of the procedure 200, the UE may perform the one or more AI/ML tasks based on the configuration. At 220 of the procedure 200, the UE may transmit one or more reports associated with the AI/ML tasks. For example, the UE may transmit a CSI report based on the CSI prediction, CSI compression, and/or beam management tasks.

The network may configure the one or more AI/ML tasks at 212 to be within the reported aiPU capabilities of the UE. However, there may be instances in which the network configures more concurrent AI/ML tasks than are supported by the reported aiPU capabilities. In this case, the UE may not be expected to perform one or more AI/ML tasks (e.g., at 216) and/or transmit a report associated with one or more AI/ML tasks (e.g., at 220) that exceed the reported capabilities. The UE may select the tasks to perform and/or the reports to send based on one or more priority rules, e.g., as described further herein.

In an example, the aiPU capability (e.g., indicated at 208) may be indicated per component carrier (CC) and/or across all CCs. For example, the UE may indicate a maximum number of aiPUs supported simultaneously per CC (e.g., simultaneousAI-Processing-perCC) and/or across all CCs (e.g., simultaneousAI-Processing-AllCC).

In some embodiments, the aiPU capability may indicate a total number of aiPUs supported for multiple (e.g., all) AI/ML use cases (e.g., types of AI/ML task). It is envisioned that the AI/ML use cases may include currently supported use cases and/or future use cases, such as CSI prediction, CSI compression, beam management, DMRS estimation, CSI-RS estimation, positioning, sensing, and/or other use cases.

In some embodiments, one or more use cases may be excluded from the total number of supported aiPUs and/or associated with a separately reported processing capability. For example, one or more use cases that are less delay sensitive (e.g., have a longer delay requirement), such as AI-based positioning, may be excluded from the total number of simultaneously supported aiPUs. Accordingly, the UE may be configured to perform AI-based positioning even if the maximum number of supported aiPUs are occupied (e.g., with other tasks). The UE may perform the less delay sensitive task (e.g., AI-based positioning) as processing resources allow.

In another example, an AI/ML use case may or may not be included in the total number of simultaneously supported aiPUs depending on the context. For example, in some embodiments, AI-based sensing may be performed in conjunction with positioning, which is less delay sensitive. In this case, the AI-based sensing may not be counted as part of the total aiPUs that may be handled simultaneously. However, when AI-based sensing is used for sensing-aided communication and/or another use case that is more delay sensitive, then the AI-based sensing may be included in the total aiPUs.

In some embodiments, the UE may additionally or alternatively report an aiPU capability for a subset of one or more AI/ML use cases. The subset-level capability information may enable flexible computing resource grouping and/or budgeting. For example, an AI processing hardware resource may be shared among multiple AI/ML use cases. Additionally, or alternatively, a different number of hardware resources may be used for different AI/ML use cases.

In an example, the aiPU capability may indicate a maximum number of simultaneous aiPUs for respective individual AI/ML use cases, such as beam management, CSI prediction, CSI compression, and/or DMRS estimation. The supported aiPUs for individual use cases may be reported per CC and/or across all CCs.

Note that the sum of the supported aiPUs for individual use cases may exceed the total number of supported aiPUs (which may also be reported). Accordingly, the UE may be expected to concurrently handle combinations of different AI/ML tasks that are within the respective capabilities for the individual AI/ML use cases and collectively within the total capability. In an illustrative example, a UE may report a total aiPU capability of 5 aiPUs (e.g., a total maximum of 5 simultaneous AI inferences across all use cases), a capability for AI-based beam management of 4 aiPUs (e.g., a maximum of 4 simultaneous AI-based beam management inferences), a capability for AI-based CSI prediction of 3 aiPUs (e.g., a maximum of 3 simultaneous AI-based CSI prediction inferences), and a capability for AI-based CSI compression of 2 aiPUs (e.g., a maximum of 2 simultaneous AI-based CSI compression tasks). If AI-based beam management is configured without other AI/ML tasks, the network may configure (and the UE may be expected to handle) up to 4 AI based beam management reports. If both AI-based beam management and AI-based CSI prediction are activated, the network may configure (and the UE may be expected to handle) 4 AI-based beam management reports and 1 AI-based CSI prediction report; or 3-AI based beam management reports and 2 AI-based CSI prediction reports; or 2-AI based beam management reports and 3 AI-based CSI prediction reports.

In another example, the aiPU capability may indicate a maximum number of simultaneous aiPUs supported for at least one subset of one or more AI/ML use cases. For example, a subset may include two or more AI/ML use cases. In an example, the UE may report aiPU capability information for a first subset that includes AI-based CSI prediction and AI-based CSI-RS estimation and/or a second subset that includes AI-based beam management. The subset capability information may be reported in addition to the total aiPU capability and/or the per-use case aiPU capability. The different levels of reporting may provide flexibility in managing hardware resources of the UE for different AI/ML tasks.

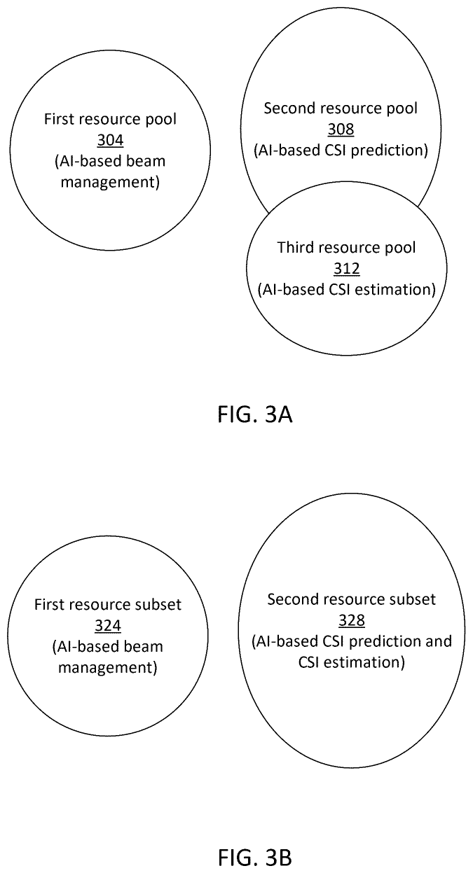

FIG. 3A illustrates an example of per-use case aiPU resource pools (e.g., sets) corresponding to respective aiPU capabilities, in accordance with some embodiments. For example, a first resource pool 304 may be supported for AI-based beam management, a second resource pool 308 may be supported for AI-based CSI prediction, and a third resource pool 312 may be supported for AI-based CSI-RS estimation. In some embodiments, the UE may use at least some common hardware resources for CSI prediction and CSI-RS estimation. Accordingly, the reported total aiPU capability may be less than the total of the per-use case aiPU capabilities.

FIG. 3B illustrates an example of aiPU subsets with one or more subsets corresponding to two or more AI/ML use cases, in accordance with some embodiments. A first subset 324 may be supported for both AI-based CSI prediction and AI-based CSI-RS estimation. A second subset 328 may be supported for AI-based beam management.

In some instances, the network may configure AI/ML tasks (e.g., AI-ML-based reports) for a UE that exceed the supported aiPUs of the UE (e.g., in a time slot). Additionally, or alternatively, the network may schedule insufficient reporting resources to transmit all configured reports. The UE may drop one or more AI/ML tasks and/or associated reports based on one or more priority rules.

In an example, aperiodic reports may have higher priority than semi-persistent reports and/or periodic reports. Semi-persistent reports may have higher priority than periodic reports. In another example, a report to be transmitted on a PUSCH may have higher priority than a report to be transmitted on PUCCH.

In another example, an L1-RSRP and/or L1-signal-to-interference plus noise ratio (SINR) with corresponding beam index may have a higher priority than other report quantities. Accordingly, an AI/ML task used to generate an L1-RSRP and/or L1-SINR may be prioritized over one or more other AI/ML tasks.

In another example, the priority for AI/ML tasks and/or reports for different cells may be based on the respective cell indexes. For example, a lower cell index may have a higher priority. In another example, the priority for AI/ML tasks associated with different reports may be based on a report configuration ID (reportConfigID). For example, a lower report configuration ID may have a higher priority.

Various embodiments herein further provide mechanisms to define how many aiPUs are allocated for respective AI/ML tasks and/or associated reports. In legacy CSI reporting, TS 38.214 defines counting rules that indicate the number of CPUs per report quantity. However, AI model complexity (and required hardware resources) can vary widely across different models.

In some embodiments, the number of aiPUs occupied by respective AI sub-use cases may be predefined (e.g., in the 3GPP TS), such as via one or more counting rules. Example sub-use cases may include beam management sub-use case 1 (spatial domain prediction for top-K beams and/or L1-RSRP), beam management sub-use case 2 (time domain prediction to M future predictions), and/or AI-based CSI prediction, among others. In an example, the number of occupied aiPUs (O_aipu) may be equal to 1 for beam management sub-use case 1 (spatial domain prediction for top-K beams and/or L1 RSRP). In another example, for beam management sub-use case 2 (time domain prediction to M future predictions), O_aipu may be equal to M (e.g., the number of future predictions). In another example, for AI-based CSI prediction, O_aipu may be equal to a number of CSI-RS ports and/or associated predictions (e.g., N4) for the report.

In other embodiments, the UE may report aiPU occupancy information to the network. For example, the aiPU occupancy information may be reported in UE capability information, such as in the UE capability indication 208 of procedure 200 (e.g., that also indicates one or more aiPU capabilities of the UE as described herein). The aiPU occupancy information may include a value of O_aipu for one or more AI/ML tasks (e.g., sub-use cases).

In some embodiments, the reported value of O_aipu may be based on one or more parameters related to the AI/ML task (e.g., inference-related parameters). For example, for AI-based beam management, O_aipu may be based on a size of set A (the number of beams that are measured for beam prediction) and/or set B (the number of beams that are predicted based on the measured beams). In an example, the network may transmit an indication to the UE to indicate one or more parameters associated with a requested aiPU occupancy value. In some embodiments, the UE may report multiple aiPU occupancy values for a same AI/ML task with different sets of one or more parameters.

In some embodiments, a number of aiPUs occupied for AI-based positioning may be based on a duration of downlink (DL) positioning reference signal (PRS) symbols N (e.g., in units of ms) a UE can process every T ms assuming maximum DL PRS bandwidth in MHz, which may be supported and reported by the UE. In an example, the aiPU may be based on a reference time T_bar estimated from the duration described above. In another example, the aiPU may be based on the number of DL PRS symbols N_bar (e.g., in units of ms) that a UE can process every reference time T_bar (e.g., in units of ms).

In another example, the number of aiPUs occupied for AI-based positioning may be based on a maximum number of DL PRS resources that a UE can process in a slot. In an example, the aiPU may be based on the ratio between the maximum number of DL PRS resources that the UE can process in a slot under and a reference number of DL PRS resources that map to a single aiPU.

In some embodiments, fractional aiPUs (e.g., non-integer values, such as a value less than 1 or between two integer values) may be supported for an aiPU occupancy value. For example, some use cases may require a lower amount of processing power. The fractional aiPU occupancy value may include, for example, 0.25, 0.5, 0.75, and/or another suitable value.

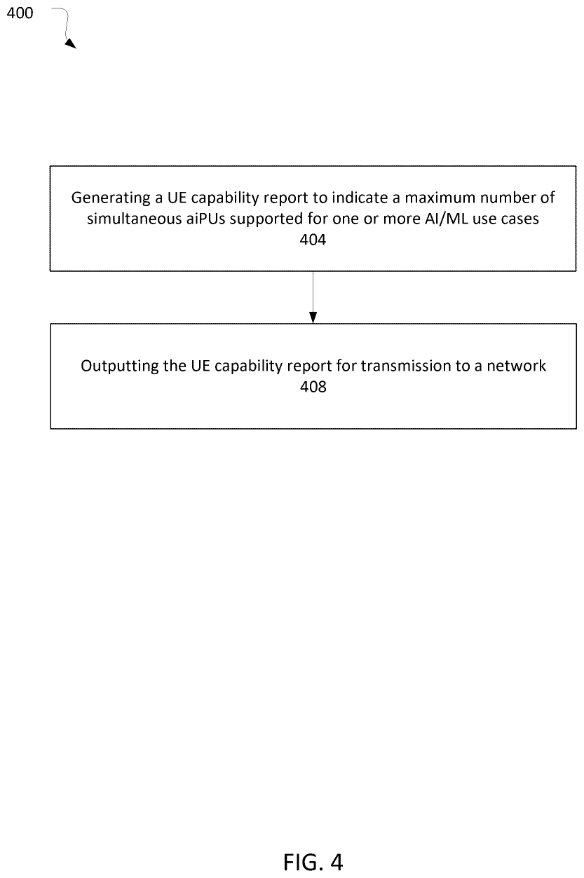

FIG. 4 is an operation flow/algorithmic structure 400 in accordance with some embodiments. The operation flow/algorithmic structure 400 may be implemented by a UE such as, for example, UE 104, UE 700, or components thereof; for example, a baseband processor 704A.

The operation flow/algorithmic structure 400 may include, at 404, generating a UE capability report to indicate a maximum number of simultaneous aiPUs supported for one or more AI/ML use cases. For example, the indicated maximum number may be for an individual AI/ML use case or a subset of two or more AI/ML use cases. In some embodiments, the UE capability report may further indicate a maximum total number of simultaneous aiPUs supported across a set of multiple AI/ML use cases that includes the one or more AI/ML use cases and one or more other AI/ML use cases. For example, the set of AI/ML use cases may include all AI/ML use cases supported by the UE. In another example, the set of AI/ML use cases may exclude one or more AI/ML use cases, such as the positioning use case. A separate indication may be included to indicate a maximum number of simultaneous aiPUs supported for the excluded use case.

In some embodiments, the UE capability report may further indicate an aiPU occupancy value to indicate a number of aiPUs allocated to an AI/ML task (e.g., report) associated with at least one of the one or more AI/ML use cases. In an example, the aiPU occupancy value may be based on one or more parameters associated with the AI/ML task.

The operation flow/algorithmic structure 400 may further include, at 408, outputting the UE capability report for transmission to a network. For example, the UE capability report may be transmitted via RRC signaling, such as in UE assistance information.

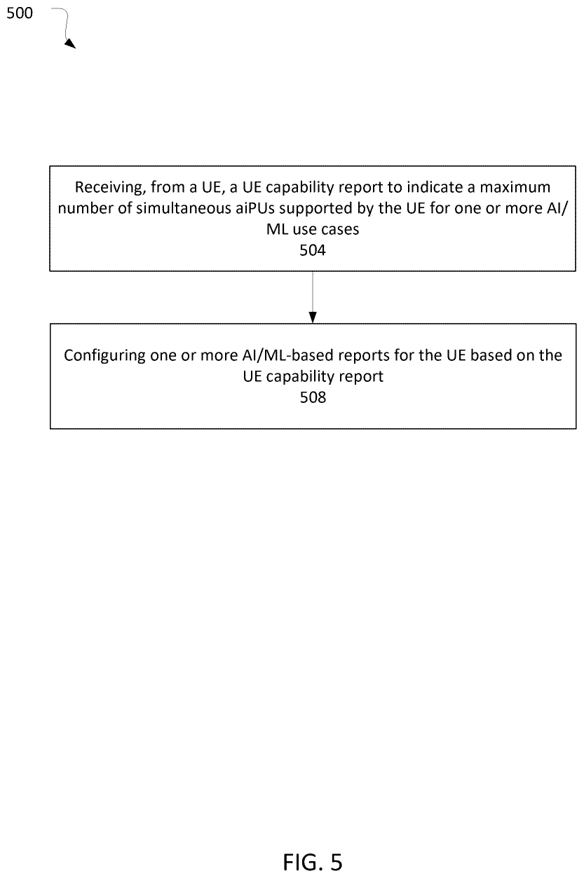

FIG. 5 illustrates another operation flow/algorithmic structure 500 in accordance with some embodiments. The operation flow/algorithmic structure 500 may be implemented by a network device such as, for example, base station 108, network device 800, or components thereof; for example, a baseband processor 804A.

The operation flow/algorithmic structure 500 may include, at 504, receiving, from a UE, a UE capability report to indicate a maximum number of simultaneous aiPUs supported by the UE for one or more AI/ML use cases. For example, the indicated maximum number may be for an individual AI/ML use case or a subset of two or more AI/ML use cases. In some embodiments, the UE capability report may further indicate a maximum total number of aiPUs supported across a set of multiple AI/ML use cases that includes the one or more AI/ML use cases and one or more other AI/ML use cases. For example, the set of AI/ML use cases may include all AI/ML use cases supported by the UE. In another example, the set of AI/ML use cases may exclude one or more AI/ML use cases, such as the positioning use case. A separate indication may be included to indicate a maximum number of simultaneous aiPUs supported for the excluded use case.

In some embodiments, the UE capability report may further indicate an aiPU occupancy value to indicate a number of aiPUs allocated to an AI/ML task (e.g., report) associated with at least one of the one or more AI/ML use cases. In an example, the aiPU occupancy value may be based on one or more parameters associated with the AI/ML task.

The operation flow/algorithmic structure 500 may further include, at 508, configuring one or more AI/ML-based reports for the UE based on the UE capability report. For example, the network may configure one or more AI/ML-based reports to be within the aiPU capabilities of the UE. In some instances, the AI/ML-based reports may exceed the aiPU capabilities of the UE in a time slot and the UE may drop one or more of the AI/ML-based reports based on one or more priority rules.

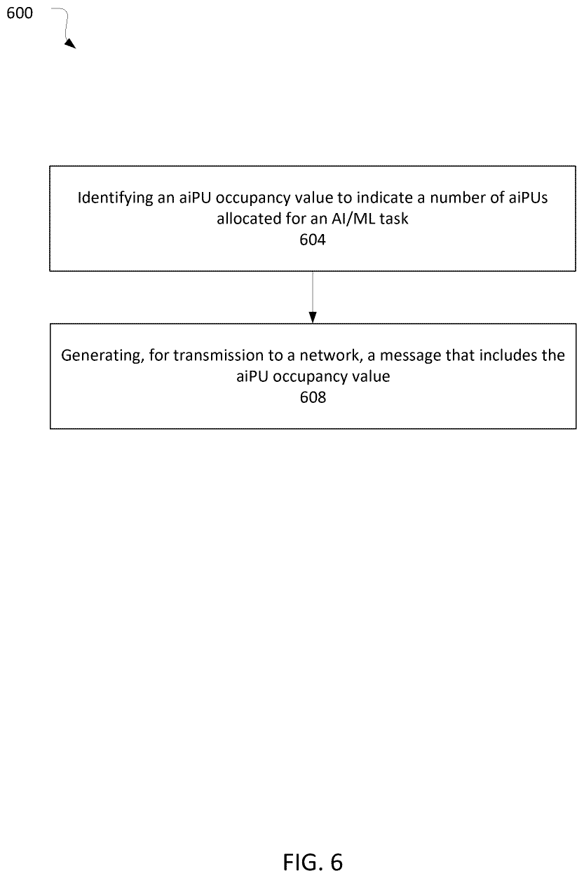

FIG. 6 is another operation flow/algorithmic structure 600 in accordance with some embodiments. The operation flow/algorithmic structure 600 may be implemented by a UE such as, for example, UE 104, UE 700, or components thereof; for example, a baseband processor 704A.

The operation flow/algorithmic structure 600 may include, at 604, identifying an aiPU occupancy value to indicate a number of aiPUs allocated for an AI/ML task. For example, the AI/ML task may correspond to a type of AI/ML-based report.

The operation flow/algorithmic structure 600 may further include, at 608, generating, for transmission to a network, a message that includes the aiPU occupancy value.

In some embodiments, the aiPU occupancy value may be based on one or more parameters associated with the AI/ML task (e.g., report). In some embodiments, the one or more parameters may be configured by the network and/or indicated by the UE in the message.

In an example, the aiPU occupancy value may be transmitted via RRC signaling, such as in UE assistance information.

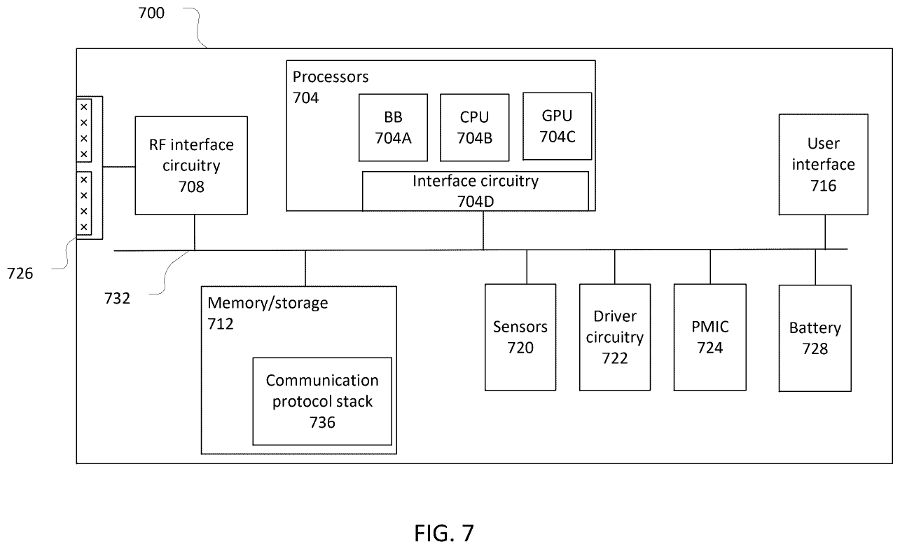

FIG. 7 illustrates a UE 700 in accordance with some embodiments. The UE 700 may be similar to and substantially interchangeable with UE 104.

The UE 700 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 700 may include processors 704, RF interface circuitry 708, memory/storage 712, user interface 716, sensors 720, driver circuitry 722, power management integrated circuit (PMIC) 724, antenna 726, and battery 728. The components of the UE 700 may be implemented as integrated circuits (ICs), portions thereof, discrete electronic devices, or other modules, logic, hardware, software, firmware, or a combination thereof. In some embodiments, at least one processor 704 may include RF interface circuitry 708. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 732, which may represent any type of interface, input/output, bus (local, system, or expansion), transmission line, trace, or optical connection that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the UE 700 to perform operations associated with aiPU capabilities as described herein. The processors 704 may also include interface circuitry 704D to enable communication by, for example, communicatively coupling the processor circuitry with one or more other components of the UE 700.

In some embodiments, the baseband processor 704A may access a communication protocol stack 736 in the memory/storage 712 to communicate over a 3GPP compatible network. In general, the baseband processor 704A may access the communication protocol stack 736 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 708.

The baseband processor 704A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to perform various operations as described herein including, for example, operation flow/algorithmic structure 400 of FIG. 4 and/or operation flow/algorithmic structure 600 of FIG. 6.

The memory/storage 712 includes any type of volatile or non-volatile memory that may be distributed throughout the UE 700. In some embodiments, some of the memory/storage 712 may be located on the processors 704 themselves (for example, memory/storage 712 may be part of a chipset that corresponds to the baseband processor 704A), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 708 may include transceiver circuitry and a radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple input, multiple output communications. The antenna 726 may include microstrip antennas, printed antennas fabricated on the surface of one or more printed circuit boards, patch antennas, or phased array antennas. The antenna 726 may have one or more panels designed for specific frequency bands including bands in FR1 or FR2.

The user interface 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 700.

The sensors 720 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various input/output (I/O) devices that may be present within, or connected to, the UE 700. For example, driver circuitry 722 may include a display driver to control and allow access to a display device, a touchscreen driver to control and allow access to a touchscreen interface, sensor drivers to obtain sensor readings of sensors 720 and control and allow access to sensors 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

A battery 728 may power the UE 700, although in some examples the UE 700 may be mounted deployed in a fixed location and may have a power supply coupled to an electrical grid. The battery 728 may be a lithium ion battery, a metal-air battery, such as a zinc-air battery, an aluminum-air battery, a lithium-air battery, and the like. In some implementations, such as in vehicle-based applications, the battery 728 may be a typical lead-acid automotive battery.

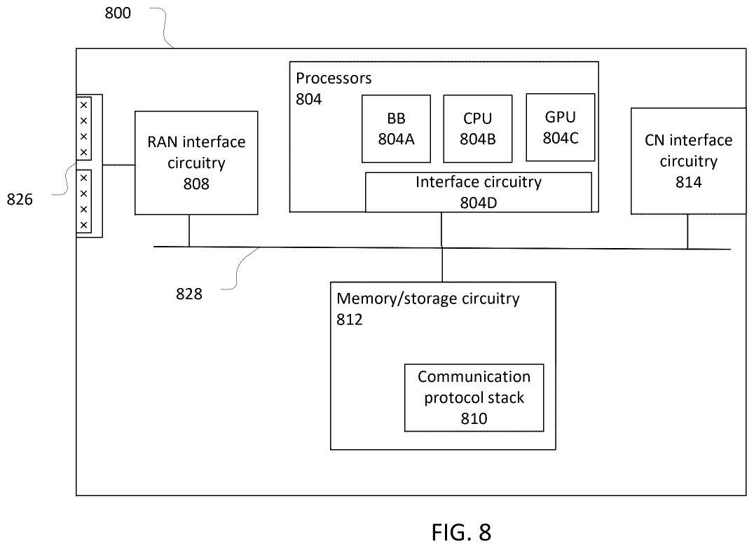

FIG. 8 illustrates a network device 800 in accordance with some embodiments. The network device 800 may be similar to and substantially interchangeable with base station 108 or a device of the core network 112 or external data network 120.

The network device 800 may include processors 804, RF interface circuitry 808 (if implemented as a base station), core network (CN) interface circuitry 814, memory/storage circuitry 812, and antenna structure 826.

The components of the network device 800 may be coupled with various other components over one or more interconnects 828.

The processors 804, RF interface circuitry 808, memory/storage circuitry 812 (including communication protocol stack 810), antenna structure 826, and interconnects 828 may be similar to like-named elements shown and described with respect to FIG. 7. In some embodiments, at least one processor 804 may include RF interface circuitry 808.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage circuitry 812 to cause the network device 800 to perform operations related to aiPU capabilities as described herein including, for example, operation flow/algorithmic structure 500 of FIG. 5. The processors 804 may also include interface circuitry 804D to enable communication by, for example, communicatively coupling the processor circuitry with one or more other components of the network device 800.

The CN interface circuitry 814 may provide connectivity to a core network, for example, a 5th Generation Core network (5GC) using a 5GC-compatible network interface protocol such as carrier Ethernet protocols, or some other suitable protocol. Network connectivity may be provided to/from the network device 800 via a fiber optic or wireless backhaul. The CN interface circuitry 814 may include one or more dedicated processors or FPGAs to communicate using one or more of the aforementioned protocols. In some implementations, the CN interface circuitry 814 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.

Example 1 includes a method comprising: generating a user equipment (UE) capability report to indicate a maximum number of simultaneous artificial intelligence processing units (aiPUs) supported for one or more artificial intelligence (AI)/machine learning (ML) use cases; and outputting the UE capability report for transmission to a network.

Example 2 includes the method of example 1, wherein the UE capability report further indicates a maximum total number of simultaneous aiPUs supported for a set of AI/ML use cases that includes the one or more AI/ML use cases and one or more other AI/ML use cases.

Example 3 includes the method of example 2, wherein the maximum number of simultaneous aiPUs supported is indicated for a sub-pool of at least two AI/ML use cases.

Example 4 includes the method of example 2, wherein an AI-based positioning use case is excluded from the set of AI/ML use cases, and wherein the UE capability report further indicates a maximum number of simultaneous aiPUs supported for the AI-based positioning use case.

Example 5 includes the method of example 1, wherein the maximum number of simultaneous aiPUs supported is indicated for an individual AI/ML use case.

Example 6 includes the method of example 1, wherein the maximum number is a first maximum number of simultaneous aiPUs supported per component carrier (CC), and the UE capability report further indicates a second maximum number of simultaneous aiPUs supported for the one or more AI/ML use cases across all CCs.

Example 7 includes the method of example 1, wherein the UE capability report further indicates an aiPU occupancy value for an AI/ML-based report associated with at least one of the one or more AI/ML use cases.

Example 8 includes the method of example 7, wherein the aiPU occupancy value is based on one or more parameters associated with the AI/ML-based report.

Example 9 includes the method of example 1, further comprising: receiving configuration information to configure a plurality of AI/ML-based reports; identifying that the plurality of AI/ML-based reports exceed the indicated number of aiPUs in a time slot; determining, based on a priority rule, a subset of the AI/ML-based reports to generate for transmission; and generating, for transmission, the subset of AI/ML-based reports.

Example 10 includes the method of example 9, wherein the priority rule includes that: an aperiodic report has a higher priority than a semi-persistent report and a periodic report; the semi-persistent report has a higher priority than the periodic report; a layer 1 (L1)-reference signal received power (RSRP) or an L1-signal-to-interference plus noise ratio (SINR) has a higher priority than other report quantities; a lower cell index has a higher priority than a higher cell index; or a lower report configuration identifier has a higher priority than a higher report configuration identifier.

Example 11 includes a method comprising: receiving, from a user equipment (UE), a UE capability report to indicate a maximum number of simultaneous artificial intelligence processing units (aiPUs) supported by the UE for one or more artificial intelligence (AI)/machine learning (ML) use cases; and configuring one or more AI/ML-based reports for the UE based on the UE capability report.

Example 12 includes the method of example 11, wherein the UE capability report further indicates a maximum total number of simultaneous aiPUs supported for a set of AI/ML use cases that includes the one or more AI/ML use cases and one or more other AI/ML use cases.

Example 13 includes the method of example 12, wherein the maximum number of simultaneous aiPUs supported is indicated for a subset of at least two AI/ML use cases.

Example 14 includes the method of example 12, wherein an AI-based positioning use case is excluded from the set of AI/ML use cases, and wherein the UE capability report further indicates a maximum number of simultaneous aiPUs supported for the AI-based positioning use case.

Example 15 includes the method of example 11, wherein the maximum number is a first maximum number of simultaneous aiPUs supported per component carrier (CC), and the UE capability report further indicates a second maximum number of simultaneous aiPUs supported for the one or more AI/ML tasks across all CCs.

Example 16 includes the method of example 11, wherein the UE capability report further indicates an aiPU occupancy value for a first AI/ML report associated with the one or more AI/ML use cases.

Example 17 includes the method of example 16, wherein the aiPU occupancy value is based on one or more parameters associated with the first AI/ML report.

Example 18 includes an apparatus comprising processor circuitry to: identify an artificial intelligence processing unit (aiPU) occupancy value to indicate a number of aiPUs allocated for an artificial intelligence (AI)/machine learning (ML) task; and generate, for transmission to a network, a message that includes the aiPU occupancy value. The apparatus may further comprise interface circuitry coupled to the processor circuitry to enable communication.

Example 19 includes the apparatus of example 18, wherein the aiPU occupancy value is based on one or more parameters associated with the AI/ML task.

Example 20 includes the apparatus of example 18, wherein the message further indicates a maximum number of aiPUs supported for an AI/ML use case corresponding to the AI/ML task.

Example 21 includes the apparatus of example 20, wherein the AI/ML use case is a first AI/ML use case and wherein the message further indicates a total maximum number of aiPUs supported for a set of AI/ML use cases that includes the first AI/ML use case and one or more other AI/ML use cases.

Another example may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Another example may include an apparatus comprising logic, modules, or circuitry to perform one or more elements of a method described in or related to any of examples 1-21, or any other method or process described herein.

Another example may include a method, technique, or process as described in or related to any of examples 1-21, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-21, or portions thereof.

Another example may include a signal as described in or related to any of examples 1-21, or portions or parts thereof.

Another example may include a datagram, information element, packet, frame, segment, PDU, or message as described in or related to any of examples 1-21, or portions or parts thereof, or otherwise described in the present disclosure.

Another example may include a signal encoded with data as described in or related to any of examples 1-21, or portions or parts thereof, or otherwise described in the present disclosure.

Another example may include a signal encoded with a datagram, IE, packet, frame, segment, PDU, or message as described in or related to any of examples 1-21, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Another example may include a computer program comprising instructions, wherein execution of the program by a processing element is to cause the processing element to carry out the method, techniques, or process as described in or related to any of examples 1-21, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
generating a user equipment (UE) capability report to indicate a maximum number of processing units (PUs) supported for at least one artificial intelligence or machine learning (AI/ML) use case; and
outputting the UE capability report for transmission to a network.

2. The method of claim 1, wherein the UE capability report further indicates a maximum total number of simultaneous PUs supported for a set of AI/ML use cases that includes the at least one AI/ML use case and one or more other AI/ML use cases.

3. The method of claim 2, wherein an AI-based positioning use case is excluded from the set of AI/ML use cases, and wherein the UE capability report further indicates a maximum number of PUs supported for the AI-based positioning use case.

4. The method of claim 1, wherein the maximum number of simultaneous PUs supported is indicated for a sub-pool of at least two AI/ML use cases.

5. The method of claim 1, wherein the maximum number is a first maximum number for a first set of at least one AI/ML use case and the UE capability report further indicates a second maximum number of PUs supported for a second set of at least one AI/ML use case.

6. The method of claim 1, wherein the maximum number is a first maximum number of PUs supported per component carrier (CC), and the UE capability report further indicates a second maximum number of simultaneous PUs supported for the at least one AI/ML use case across all CCs.

7. The method of claim 1, wherein the UE capability report further indicates a PU occupancy value for an AI/ML-based report associated with at least one of the at least one AI/ML use case.

8. The method of claim 7, wherein the PU occupancy value is based on at least one parameter associated with the AI/ML-based report.

9. The method of claim 1, further comprising:
receiving configuration information to configure a plurality of AI/ML-based reports;
identifying that the plurality of AI/ML-based reports exceed the indicated number of PUs in a time slot;
determining, based on a priority rule, a subset of the AI/ML-based reports to generate for transmission; and
generating, for transmission, the subset of AI/ML-based reports.

10. The method of claim 9, wherein the priority rule includes that:
an aperiodic report has a higher priority than a semi-persistent report and a periodic report;
the semi-persistent report has a higher priority than the periodic report;
a layer 1 (L1)-reference signal received power (RSRP) or an L1-signal-to-interference plus noise ratio (SINR) has a higher priority than other report quantities;
a lower cell index has a higher priority than a higher cell index; or
a lower report configuration identifier has a higher priority than a higher report configuration identifier.

11. A method comprising:
receiving, from a user equipment (UE), UE capability information to indicate a maximum number of simultaneous processing units (PUs) supported by the UE for at least one artificial intelligence (AI)/machine learning (ML) use case; and
generating, for transmission to the UE, configuration information to configure at least one AI/ML-based report for the UE based on the UE capability information.

12. The method of claim 11, wherein the UE capability information further indicates a maximum total number of simultaneous PUs supported for a set of AI/ML use cases that includes the at least one AI/ML use case and at least one other AI/ML use case.

13. The method of claim 11, wherein the maximum number of simultaneous PUs supported is indicated for a subset of at least two AI/ML use cases.

14. The method of claim 11, wherein the maximum number is a first maximum number for a first set of at least one AI/ML use case and the UE capability information further indicates a second maximum number of PUs supported for a second set of at least one AI/ML use case.

15. The method of claim 11, wherein the maximum number is a first maximum number of simultaneous aiPUs supported per component carrier (CC), and the UE capability report further indicates a second maximum number of simultaneous aiPUs supported for the one or more AI/ML tasks across all CCs.

16. The method of claim 11, wherein the UE capability information further indicates a PU occupancy value for at least one AI/ML report associated with the at least one AI/ML use case.

17. An apparatus comprising:
processor circuitry to:
identify an processing unit (PU) occupancy value to indicate a number of PUs allocated by a user equipment (UE) for an artificial intelligence or machine learning (AI/ML) task; and
generate, for transmission to a network, UE capability information to indicate the PU occupancy value; and
interface circuitry coupled to the processor circuitry to transmit the UE capability information.

18. The apparatus of claim 17, wherein the PU occupancy value is a first PU occupancy value that applies to a first set of PUs and the UE capability information further indicates a second PU occupancy value that applies to a second set of PUs.

19. The apparatus of claim 17, wherein the message further indicates a maximum number of PUs supported for an AI/ML use case corresponding to the AI/ML task.

20. The apparatus of claim 17, wherein the AI/ML task includes generating a channel state information (CSI) report based on at least one inference.
